(19) United States
(12) Patent Application Publication
(10) Pub. No.: US 2025/0225372 A1
(43) Pub. Date: Jul. 10, 2025

(54) EVALUATION PLATFORM FOR GENERATIVE ARTIFICIAL INTELLIGENCE SYSTEMS

(71) Applicant: Microsoft Technology Licensing, LLC, Redmond, WA (US)

(72) Inventors: Nitant SINGH, Sammamish, WA (US); Vincent LONGPRÉ, St-Hubert (CA)

(21) Appl. No.: 18/405,367

(22) Filed: Jan. 5, 2024

(51) Int. Cl. G06N 3/0455

(52) U.S. Cl. CPC G06N 3/0455

(57) ABSTRACT

An evaluation request user interface display is generated for interaction by a user. The user interacts with the evaluation request user interface display to specify evaluation parameters. An evaluation pipeline selection system selects an evaluation pipeline based upon the selected evaluation parameters. The evaluation pipeline processes the evaluation parameters and submits evaluation data to an LLM to obtain evaluation results. The evaluation pipeline outputs the valuation results for interaction by the user who initiated the evaluation request.

### BACKGROUND

Computer systems are currently in wide use. Some computer systems include generative artificial intelligence (AI) systems.

Some generative AI systems are hosted for access by different customers or clients. Some such generative AI systems include conversation systems (or chat systems), question answering systems, classifiers, or any of a wide variety of other types of generative AI systems. The generative AI systems receive a prompt from a user or another system and then generate an output based on the prompt. The prompt may include instructions, examples, context information, and a wide variety of other information.

In some examples, the generative AI system includes a large language model (LLM). An LLM is a language model that has a large number of parameters (such as tens of billions or hundreds of billions of parameters).

The discussion above is merely provided for general background information and is not intended to be used as an aid in determining the scope of the claimed subject matter.

### SUMMARY

An evaluation request user interface display is generated for interaction by a user. The user interacts with the evaluation request user interface display to specify evaluation parameters for an evaluation request. An evaluation pipeline selection system selects an evaluation pipeline based upon the selected evaluation parameters. The evaluation pipeline processes the evaluation request and submits evaluation data to an LLM to obtain evaluation results. The evaluation pipeline outputs the evaluation results for interaction by the user who initiated the evaluation request.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of an evaluation computing system architecture.

FIG. 2 is a block diagram showing one example of a pipeline selection system in more detail.

FIG. 3 is a block diagram showing one example of a triggered pipeline in more detail.

FIGS. 4A and 4B (collectively referred to herein as FIG. 4) show a flow diagram illustrating one example of the operation of the evaluation computing system architecture and the pipeline selection system, in more detail.

FIG. 5 is a block diagram showing one example of an evaluation engineer computing system architecture.

FIG. 6 is a flow diagram illustrating one example of the operation of the evaluation engineer computing system architecture.

FIG. 7 is a block diagram showing one example of the architectures illustrated in FIGS. 1 and 5, deployed in a remote server architecture.

FIG. 8 is a block diagram showing one example of a computing environment that can be used in the architectures and systems shown in previous figures.

### DETAILED DESCRIPTION

As discussed above, many generative AI systems include LLMs. Such systems are often modified and new types of generative AI systems are implemented, so that engineers often wish to evaluate the performance of generative AI systems.

Some current LLM systems may generate different outputs for the same prompt. For instance, a prompt may be submitted to an LLM system five different times, and the LLM may generate five different responses. This makes the LLM very difficult to evaluate to determine how a particular feature of the generative AI system is performing.

Similarly, some evaluation has been based on customer feedback, but customer feedback can be unreliable and is not easy to obtain. Also, evaluation systems can run into security issues when attempting to evaluate the LLM performance based on customer data.

Thus, some engineers attempt to evaluate the performance of an LLM (or generative AI system) based on the engineer's own data. However, this is a relatively narrow set of evaluation data and the evaluation results can thus be misleading or incomplete.

Other engineers write ad hoc evaluation pipelines with components that can be used to perform the evaluation process. Such evaluation pipelines may include a set of components such as a data extraction component that performs data extraction to extract the data that is to be evaluated. The evaluation pipelines can include data processing components that manipulate the extracted data to place it into proper form to be received by the evaluation model. The evaluation pipeline can include a metric processor that is used to call an evaluation model (which may, itself, be an LLM) and to calculate one or more different evaluation metrics, and an output component that outputs evaluation results. These types of evaluation pipelines can be expensive and difficult to author.

These evaluation pipelines may also have different components or components configured in a different way based upon the data to be evaluated, the model to be evaluated, the model that is performing the evaluation, the metric to be generated, etc. It may be difficult for an engineer or other professional/individual who is seeking to have a generative AI system evaluated to know which particular pipeline to use, or to know whether a new pipeline must be designed, in order to perform the desired evaluation.

The present description thus describes a system in which a user (referred to as an LLM engineer) who wishes to have a generative AI system evaluated can interact with a user interface to select evaluation parameters (such as to identify an evaluation data set, an evaluation metric, an evaluation model that is to perform the evaluation, etc.) without authoring any code. Based upon the selected parameters, a pipeline selection system automatically identifies an evaluation pipeline (which may be stored in a repository of evaluation pipelines) that should be triggered to perform the requested evaluation. The pipeline selection system then triggers the evaluation pipeline which performs the data extraction processing, calls the evaluation models, computes the evaluation metrics, etc., and outputs the evaluation results for review and interaction by the requesting LLM engineer. The data can be output in various ways, such as in a dashboard format, in a comparative format where evaluation metrics generated for different models are compared against one another, or in other ways.

The present description also describes a system in which a user (referred to as an evaluation engineer) can author or modify or otherwise develop an evaluation pipeline (e.g., with different components), evaluation metrics or other parts of an evaluation system and check those new pipelines, metrics, etc. into a repository. The stored pipelines, metrics, etc. can then be automatically selected by the pipeline selection system. By automatically it is meant that the function or process can be performed without further human involvement except, perhaps, to initiate or authorize the function or process.

While the present description proceeds with respect to a user who wishes to have an LLM evaluated being described as an LLM engineer, it will be appreciated that the term LLM engineer includes any user who wishes to have a generative AI system evaluated.

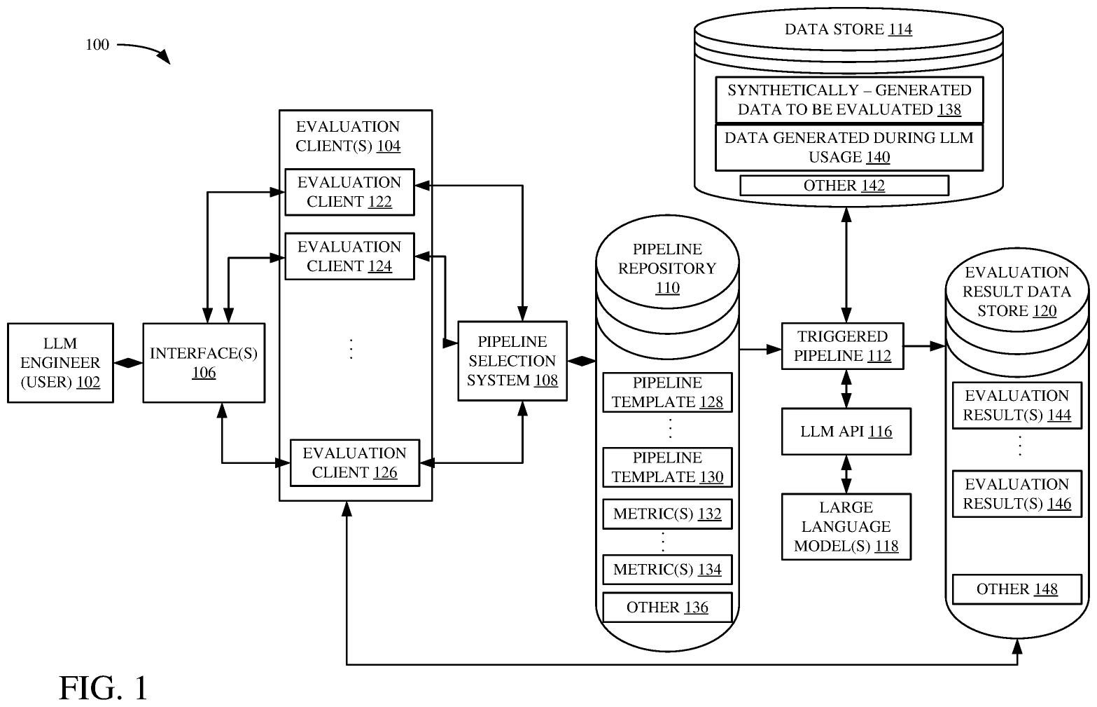

FIG. 1 is a block diagram of one example of an evaluation computing system architecture 100 in which an LLM engineer (or another user) 102 uses one or more evaluation clients 104 to generate an evaluation request by inputting evaluation parameters through an interface 106 generated by the client 104. The evaluation parameters are provided to a pipeline selection system 108 that selects an evaluation pipeline (which may be stored in pipeline repository 110) to execute the evaluation request and (either synchronously or asynchronously) triggers that evaluation pipeline (as a triggered pipeline 112) to execute the evaluation request.

The triggered pipeline 112 interacts with data store 114 to obtain data that is to be evaluated and provides that data, such as through an LLM API 116, to one or more large language models 118 that are used to perform the evaluation. Triggered pipeline 112 can then generate evaluation results (e.g., calculate one or more different evaluation metrics, etc.) and output the evaluation results for storage in evaluation result data store 120. Data store 120 makes the evaluation results available to the LLM engineer 102 through the evaluation client 104.

It can be seen in FIG. 1 that evaluation clients 104 may include a plurality of different evaluation clients 122, 124, and 126. Each of the evaluation clients 122-126 may generate a different interface 106 for interaction by LLM engineer 102. LLM engineer 102 interacts with the interface 106 generated by the particular evaluation client that LLM engineer 102 is using. The interface 106 illustratively includes a set of user input mechanisms that allow LLM engineer 102 to select or otherwise input evaluation parameters that indicate the type of evaluation that LLM engineer 102 wishes to have performed. The user input mechanisms may, for instance, be drop down menus, selectable buttons, icons, etc. that allow LLM engineer 102 to select a particular data set to be evaluated, to specify one or more different evaluation metrics that are to be computed, to identify the particular LLM 118 that is to perform the evaluation, among other things. The user input mechanisms may be actuated using a point-and-click device or a touch gesture or using speech or other inputs. In such an example, the selectable parameters that are displayed on the interface(s) 106 may be populated by the client 104 that is generating the interface(s) 106. The client 104 may have access to the LLMs 118 that are available for selection, the data sets in the data store 114 that are selectable, etc. and generate a selector on interface(s) 106 that allow LLM engineer 102 to select any of the available items.

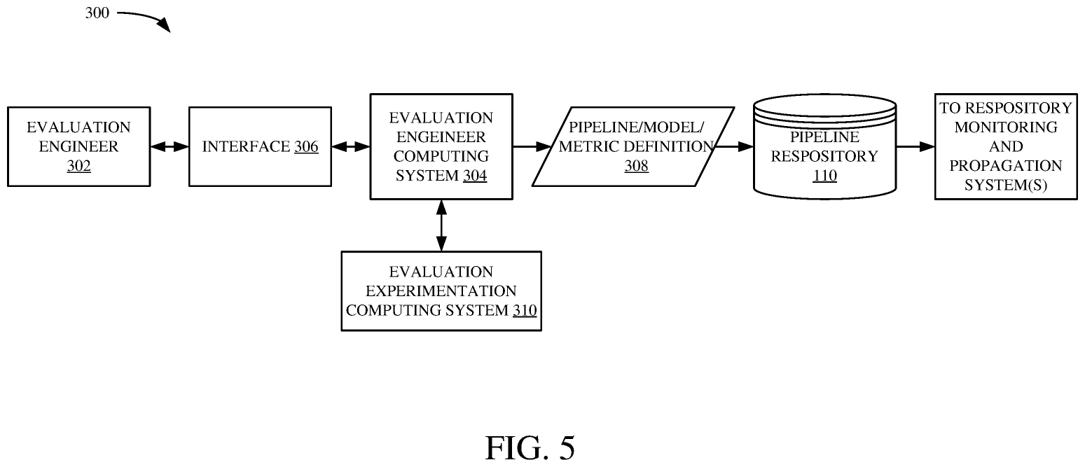

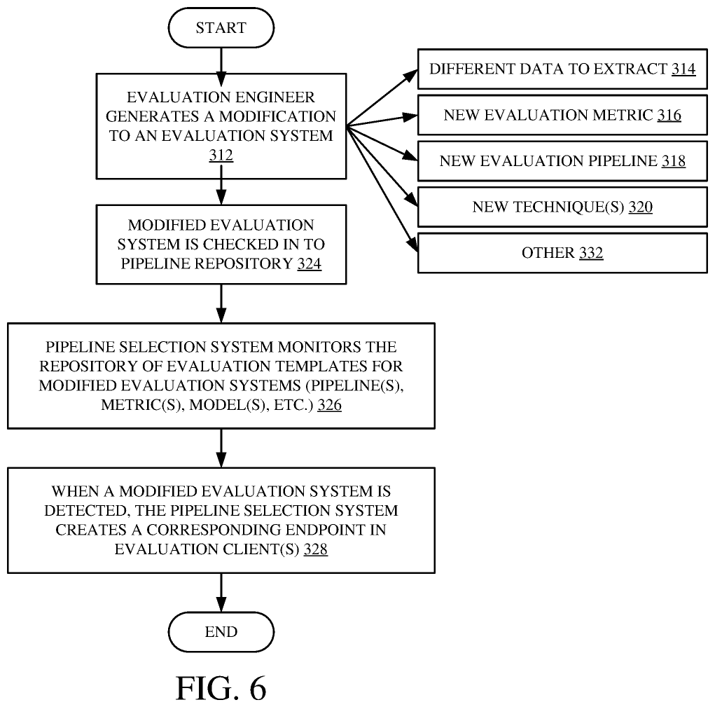

FIG. 1 also shows that pipeline repository 110 can store a plurality of different evaluation pipelines (or evaluation templates) 128-130, as well as a plurality of different evaluation metrics 132-134, among a wide variety of other things 136. Each evaluation template 128-130 may be defined by a pipeline definition generated by an evaluation engineer (discussed in greater detail below with respect to FIGS. 5-6).

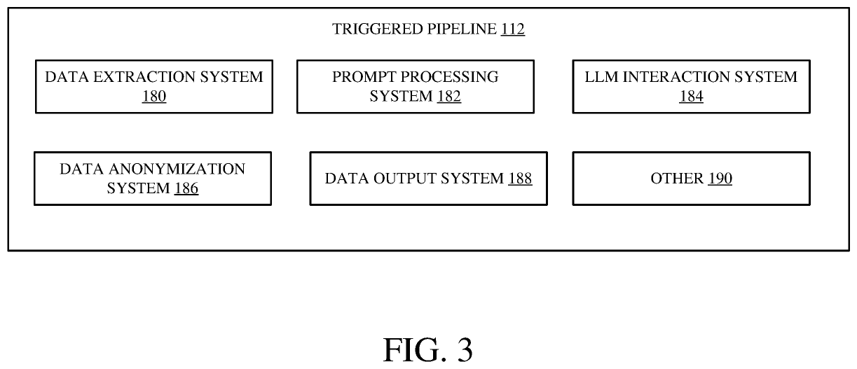

Based upon the parameters received by pipeline selection system 108, pipeline selection system 108 may select and trigger one or more of the evaluation templates 128-130 and configure them to calculate a selected evaluation metric 132-134. One example of the triggered pipeline 112 is discussed in greater detail below with respect to FIG. 3 and may include a data extraction component that can extract data to be evaluated from data store 114. Data store 114, in the example shown in FIG. 1, can include synthetically generated data to be evaluated 138, as well as data generated during actual usage of the LLM being evaluated by one or more users, as indicated by block 140. Data store 114 can include a wide variety of other data sets 142 as well.

Triggered pipeline 112 extracts the desired data sets from data store 114 and provides them through LLM API 116, along with a prompt to evaluate the data, to one or more selected large language models 118. The selected large language model 118 executes the prompt and generates an output indicative of the desired evaluation. Triggered pipeline 112 obtains the evaluation information generated by LLM 118 through LLM API 116 and can include components to calculate the different evaluation metrics, anonymize the data, and output the data to evaluation data store 120.

Evaluation data store 120 thus, in the example shown in FIG. 1, stores a plurality of sets of evaluation results 144-146, and can include a wide variety of other information 148. The evaluation client 104 that LLM engineer 102 is using may access the evaluation results and display those results on an interface 106 for use by LLM engineer 102.

It will also be noted that, in one example, LLM engineer 102 can also schedule periodic or otherwise recurrent evaluations to be performed. In that case, pipeline selection system 108 determines when an evaluation pipeline is to be triggered, based upon the scheduled evaluation operations, and triggers that evaluation pipeline accordingly.

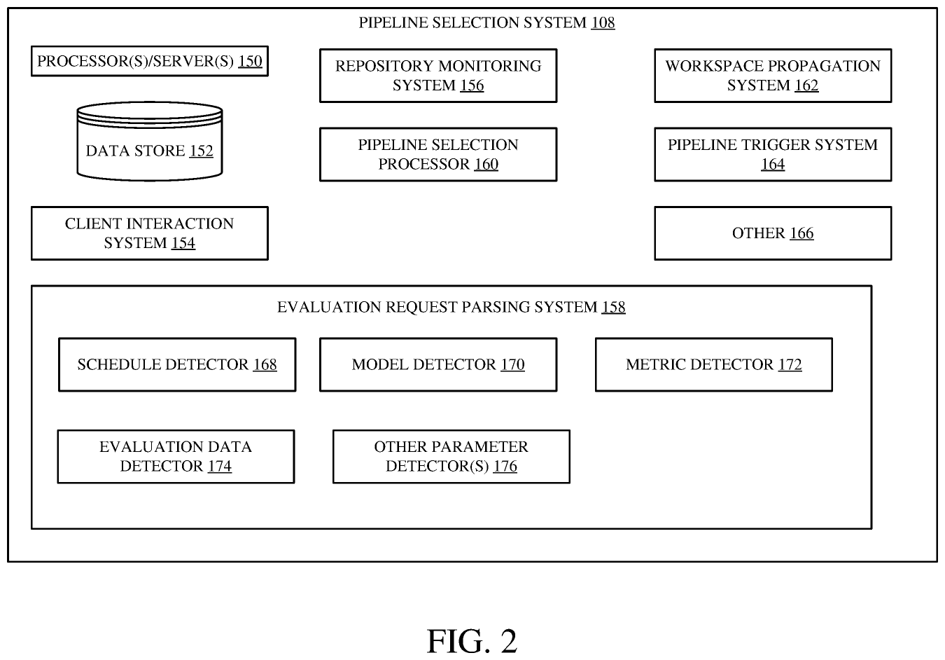

FIG. 2 is a block diagram showing one example of pipeline selection system 108 in more detail. In the example shown in FIG. 2, pipeline selection system 108 includes one or more processors or servers 150, data store 152, client interaction system 154, repository monitoring system 156, evaluation request parsing system 158, pipeline selection processor 160, workspace propagation system 162, pipeline trigger system 164, and any of a wide variety of other items or functionality 166. FIG. 2 also shows that, in one example, evaluation request parsing system 158 includes schedule detector 168, model detector 170, metric detector 172, evaluation data detector 174, and any of a wide variety of parameter detectors 176.

Client interaction system 154 interacts with the particular evaluation client 104 being used by LLM engineer 102 to submit an evaluation request. Thus, client interaction system 154 may expose an API or another interface that is engaged by the evaluation client 104 or may interact with the client 104 in other ways. Evaluation request parsing system 158 parses the evaluation request to identify the evaluation parameters needed to select and trigger one of the evaluation pipeline templates 128-130 for executing the evaluation request. In one example, the evaluation request may be provided according to a pre-defined schema. Evaluation request parsing system 158 can then identify the evaluation parameters given the pre-defined schema. In another example, evaluation request parsing system 158 can include natural language understanding functionality, or other functionality that identifies the evaluation parameters in the evaluation request. Scheduling detector 168 detects whether the evaluation request is to be scheduled (e.g., recurring) or is to be performed synchronously. Model detector 170 detects which particular LLM 118 (or set of LLMs 118) is being called to perform the evaluation. Metric detector 172 detects the evaluation metric(s) to be calculated. Evaluation data detector 174 detects the data set that is to be extracted and evaluated. Other parameter detectors 176 can detect any of a wide variety of other evaluation parameters that may be used to select and trigger an evaluation pipeline template.

Based upon the different evaluation parameters parsed from the evaluation request, pipeline selection processor 160 selects which of the evaluation pipeline templates should be triggered to perform the requested evaluation. In one example, pipeline selection processor 160 may be driven by heuristics that generate an output indicative of the selected evaluation pipeline based upon the input parameters. In another example, pipeline selection processor 160 may, itself, be an LLM or a classifier that receives, as inputs, the evaluation parameters and generates an output indicative of the selected evaluation pipeline 128-130. In one example, pipeline selection processor 160 can filter the evaluation pipeline templates 128-130 in pipeline repository 110, such as using tags or other pipeline identifiers, based upon the input parameters. Pipeline selection processor 160 can operate in other ways as well.

Pipeline trigger system 164 triggers the evaluation pipeline corresponding to the selected evaluation pipeline template, at the desired time. For instance, when the evaluation process is a scheduled process, then the selected evaluation pipeline can be triggered by pipeline trigger system 164 based on the schedule. When the evaluation pipeline is to be triggered synchronously, then pipeline trigger system 164 can trigger the evaluation pipeline upon its selection. The pipeline trigger system 164 can provide the evaluation parameters and other information from the evaluation request to the triggered evaluation pipeline. The pipeline trigger system 164 can trigger the selected evaluation pipeline in other ways as well.

As is discussed in greater detail below with respect to FIGS. 5 and 6, an evaluation engineer may generate new evaluation pipelines and/or new evaluation metrics to be stored in pipeline repository 110 so that those new evaluation pipelines and/or metrics can be selected for use during an evaluation process. In that case, the new evaluation pipelines may be deployed in different workspaces or in different environments, after they have been stored to pipeline repository 110. End points to the new pipelines can also be generated in the evaluation client systems 104 and/or elsewhere. Therefore, pipeline selection system 108 includes repository monitoring system 156 which listens to or monitors pipeline repository 110 to determine when a new evaluation pipeline, a new evaluation metric, etc., has been added by an evaluation engineer. When that occurs, repository monitoring system 156 generates an output to workspace propagation system 162 indicating that a new evaluation pipeline and/or evaluation metric, etc., has been added to pipeline repository 110. In response, workspace propagation system 162 can propagate the new evaluation pipelines across different workspaces where the pipeline can be triggered in response to evaluation requests. As mentioned, these operations are discussed in greater detail below with respect to FIGS. 5 and 6.

It will be appreciated that different evaluation pipelines can take a wide variety of different forms. However, for the sake of discussion, FIG. 3 shows one example of a triggered evaluation pipeline 112. In the example shown in FIG. 3, triggered pipeline 112 includes data extraction system 180, prompt processing system 182, LLM interaction system 184, data anonymization system 186, data output system 188, and any of a wide variety of other systems, components, or functionality 190. Data extraction system 180 extracts data that is to be evaluated from data store 114. Prompt processing system 182 can manipulate or otherwise modify the data to place the data in proper form to be received through LLM API 116 and submitted to LLMs 118 for evaluation. LLM interaction system 184 submits the data and prompts to LLMs 118 through LLM API 116 and receives the response. LLM interaction system 184 can also calculate any desired metrics based upon the responses from LLMs 118. Data anonymization system 186 anonymizes the data so it can be shared with LLM engineer 102 in a compliant manner. Data output system 188 outputs the anonymized evaluation results for storage in evaluation result data store 120 where the results can be accessed by one or more of the evaluation clients 104 or by LLM engineer 102 in other ways.

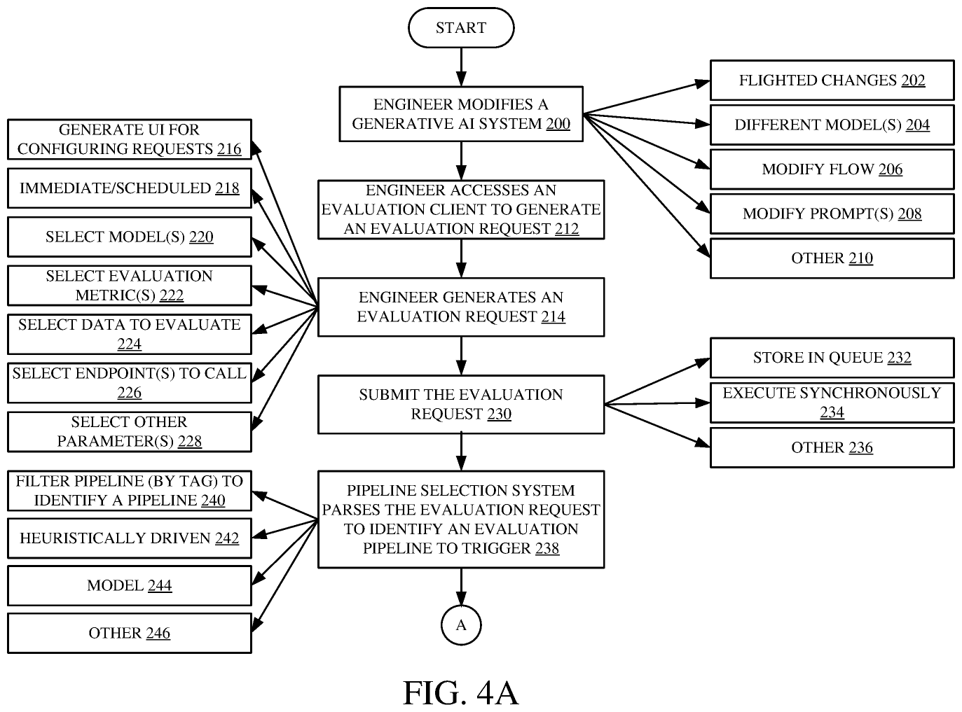

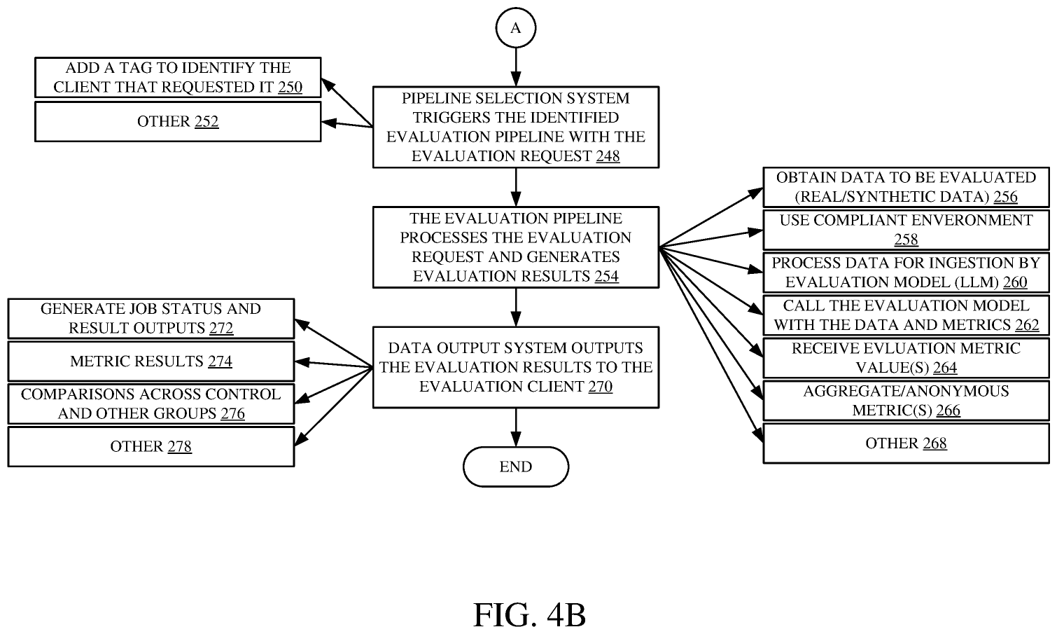

FIGS. 4A and 4B (collectively referred to herein as FIG. 4) show a flow diagram illustrating one example of the evaluation computing system architecture 100 in more detail. It is first assumed that LLM engineer 102 modifies a generative AI system. The modifications can be rolled out by LLM engineer 102 in flights, or in batches. Modifying the generative AI system is indicated by block 200 in the flow diagram of FIG. 4. Outputting the modifications as flighted changes (or intermittent sets of changes) is indicated by block 202. The changes to the generative AI system (the LLM system) can include such things as generating different models 204, modifying the flow of the AI system 206, modifying prompts 208, or any of a wide variety of other modifications to the LLM system to be evaluated, as indicated by block 210.

LLM engineer 102 can then request an evaluation by accessing an evaluation client 104 to generate an evaluation request so the modification to the LLM system can be evaluated, as indicated by block 212 in the flow diagram of FIG. 4. LLM engineer 102 then interacts with the evaluation client to generate an evaluation request, as indicated by block 214. For instance, an evaluation client 122 may generate a user interface display with user actuatable mechanisms for interaction or configuration by LLM engineer 102 in order to generate an evaluation request. Generating such a UI display is indicated by block 216 in the flow diagram of FIG. 4. The LLM engineer 102 can specify that the evaluation request is to be performed immediately, or is to be scheduled (e.g., for some time in the future, as a recurring request, etc.) as indicated by block 218 in the flow diagram of FIG. 4. LLM engineer 102 also interacts with the interface 106 to identify evaluation parameters that are to be used during the evaluation process. LLM engineer 102 can thus select the models that are to perform the evaluation as indicated by block 220, select evaluation metrics that are to be generated as indicated by block 222, select the data sets to be evaluated, as indicated by block 224, select endpoints to call in performing the evaluation, as indicated by block 226, and/or to select any of a wide variety of other parameters 228.

LLM engineer 102 then submits the evaluation request through the evaluation client 104 to pipeline selection system 108, as indicated by block 230 in the flow diagram of FIG. 4. The evaluation request can be stored in a queue for asynchronous processing, as indicated by block 232, or executed synchronously, as indicated by block 234. The evaluation request can be submitted in other ways as well, as indicated by block 236.

Evaluation request parsing system 158 parses the evaluation request to identify parameters used to select an evaluation pipeline that is to be triggered, as indicated by block 238 in the flow diagram of FIG. 4. For instance, based upon the parameters identified in the evaluation request, pipeline selection processor 160 can filter the various pipelines 128-130 in pipeline repository 110 to identify the pipeline to be triggered, as indicated by block 240 in the flow diagram of FIG. 4. The pipeline selection processor 160 can be heuristically driven, as indicated by block 242. The pipeline selection processor 160 can be an LLM or other model, as indicated by block 244, or the pipeline selection processor 160 can perform pipeline selection in any of a wide variety of other ways, as indicated by block 246 in the flow diagram of FIG. 4.

Pipeline trigger system 164 then triggers the selected evaluation pipeline, providing the evaluation parameters (or other information in the evaluation request) as indicated by block 248 in the flow diagram of FIG. 4. In one example, pipeline trigger system 164 can add a tag to the triggered pipeline to identify the particular evaluation client that requested the evaluation. Adding a tag is indicated by block 250. The tag allows evaluation clients 104 to filter triggered pipelines, based upon the tag, to identify any pipelines that the client triggered, itself. Pipeline trigger system 164 can trigger the selected pipeline in other ways as well, as indicated by block 252 in the flow diagram of FIG. 4.

The triggered evaluation pipeline 112 then processes the evaluation request and generates evaluation results, as indicated by block 254 in the flow diagram of FIG. 4. For instance, data extraction system 180 can extract data to be evaluated, as indicated by block 256. The data can be real or synthetic data, and the data can be evaluated in a compliant environment, as indicated by block 258. Prompt processing system 182 can process the data for ingestion by the evaluation model (e.g., LLM 118) as indicated by block 260. LLM interaction system 184 calls the evaluation model 118 with the data and metrics to be evaluated, as indicated by block 262. LLM interaction system 184 then receives from the evaluation model(s) 118 the evaluation metrics values or other evaluation results, as indicated by block 264 in the flow diagram of FIG. 4. LLM interaction system 184 and data anonymization system 186 can then aggregate and anonymize the metrics or other evaluation results, respectively, as indicated by block 266. The triggered evaluation pipeline 112 can perform other operations as well, as indicated by block 268.

Data output system 188 then outputs the evaluation results for access by the evaluation client 104 that generated the request. Outputting the evaluation results is indicated by block 270 in the flow diagram of FIG. 4. The evaluation results can be stored in data store 120 or output in other ways.

During processing, the pipeline 112 can generate job status outputs and result outputs so that LLM engineer 102 can, through the evaluation client 104, check on the status of the evaluation request, regardless of whether it is a scheduled request or a synchronous request. Generating job status and result outputs is indicated by block 272 in the flow diagram of FIG. 4.

The evaluation results can include the computed evaluation metric results, as indicated by block 274, and/or comparisons across control groups and other groups, as indicated by block 276. The output system 188 can generate outputs as scoreboards, as dashboards, in tabular form, or in any other of a wide variety of different ways, as indicated by block 278 in FIG. 4.

FIG. 5 is a block diagram showing one example of an evaluation engineer computing system architecture 300. In architecture 300, an evaluation engineer 302 may author different evaluation pipeline definitions and/or evaluation metrics and/or other items to be stored in pipeline repository 110 and used in executing evaluation requests. In one example, evaluation engineer computing system 304 generates an interface 306 for interaction by evaluation engineer 302. Evaluation engineer 302 can generate new models, pipelines, metrics, etc. as indicated by block 308, which can be stored in pipeline repository 110 for access by different evaluation clients 104. In one example, evaluation engineer 302 uses evaluation engineer computing system 304 to deploy the newly developed (or modified) evaluation pipeline definition model metric, etc. in an evaluation experimentation computing system or environment 310. Once the new model/metric/pipeline has been sufficiently developed, it can be stored in pipeline repository 110. In response, as discussed above, repository monitoring system 156 can detect that the new model/pipeline/metric definition has been stored in pipeline repository 110. Workspace propagation system 162 can then propagate that new definition out to different workspaces and incorporated end points in the different evaluation clients 104 so it can be used to execute evaluation requests.

FIG. 6 is a flow diagram illustrating one example of the operation of evaluation engineer computing system architecture 300, in more detail. It is first assumed that evaluation engineer 302 develops or otherwise generates a modification to an evaluation system, as indicated by block 312 in the flow diagram of FIG. 6. The modification may be a new or modified data set that may be extracted for evaluation, as indicated by block 314. The modification may be a new or modified evaluation metric or pipeline or model definition, as indicated by blocks 316 and 318 in the flow diagram of FIG. 6. The evaluation modification may be a new evaluation technique or flow, as indicated by block 320, or any of a wide variety of other modifications, as indicated by block 322.

The modified evaluation system is then checked into the pipeline repository 110, as indicated by block 324. At that point, the repository monitoring system 156 discovers the new evaluation pipeline, model, metric, etc. (e.g., a new evaluation template) as indicated by block 326 in the flow diagram of FIG. 6. When the modified evaluation system is detected, then workspace propagation system 162 can fan the modified evaluation system out to different workspaces and/or create a corresponding endpoint in different evaluation clients 104 so that the modified evaluation system can be accessed by and run at the request of the evaluation clients 104, as indicated by block 328 in the flow diagram of FIG. 6.

It can thus be seen that the present description describes a system in which a user experience is provided so that an evaluation request can be generated by simply specifying evaluation parameters, without generating code, or by generating only small amounts of code. This allows LLM engineers 102 to evaluate their generative AI scenarios at scale in an ad hoc or recurrent manner, all without the need to write code. Instead, the LLM engineers 102 leverage code artifacts created by other evaluation engineers to run evaluation requests which can be used to test new models, data sets, metrics, etc. and allow the LLM engineer to determine the suitability of the evaluated elements for different scenarios. This greatly increases the speed at which evaluations of generative AI systems can be performed, and it greatly reduces the latency in performing such evaluations. Further, the system enables the timely and efficient evaluation of new or modified generative AI systems, and also enables a developer to monitor the performance of other generative AI systems in the production environment. This all leads to better and more accurate functionality in the generative AI system.

It will be noted that the above discussion has described a variety of different systems, components, detectors, pipelines, templates, and/or logic. It will be appreciated that such systems, components, detectors, pipelines, templates, and/or logic can be comprised of hardware items (such as processors and associated memory, or other processing components, some of which are described below) that perform the functions associated with those systems, components, detectors, pipelines, templates, and/or logic. In addition, the systems, components, detectors, pipelines, templates, and/or logic can be comprised of software that is loaded into a memory and is subsequently executed by a processor or server, or other computing component, as described below. The systems, components, detectors, pipelines, templates, and/or logic can also be comprised of different combinations of hardware, software, firmware, etc., some examples of which are described below. These are only some examples of different structures that can be used to form the systems, components, detectors, pipelines, templates, and/or logic described above. Other structures can be used as well.

The present discussion has mentioned processors and servers. In one example, the processors and servers include computer processors with associated memory and timing circuitry, not separately shown. The processors and servers are functional parts of the systems or devices to which they belong and are activated by, and facilitate the functionality of the other components or items in those systems.

Also, a number of user interface (UI) displays have been discussed. The UI displays can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, the mechanisms can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which the mechanisms are displayed is a touch sensitive screen, the mechanisms can be actuated using touch gestures. Also, where the device that displays them has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

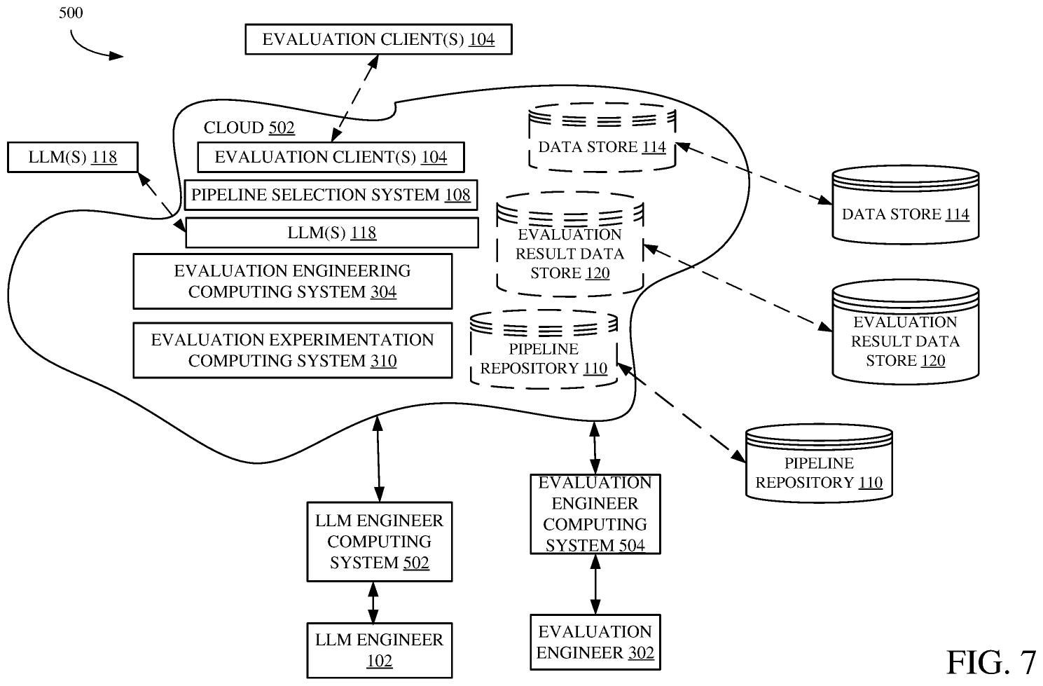

FIG. 7 is a block diagram of architectures 100 and 300, shown in FIGS. 1 and 5, except that the elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and the applications can be accessed through a web browser or any other computing component. Software or components of architectures 100 and 300 as well as the corresponding data, can be stored on servers at a remote location. The computing resources in a cloud computing environment can be consolidated at a remote data center location or the computing resources can be dispersed. Cloud computing infrastructures can deliver services through shared data centers, even though they appear as a single point of access for the user. Thus, the components and functions described herein can be provided from a service provider at a remote location using a cloud computing architecture. Alternatively, the components and functions can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 7, some items are similar to those shown in FIGS. 1 and 5 and they are similarly numbered. FIG. 7 specifically shows that systems 108, 304, and 310, clients 104, LLMs 118, and data stores 110, 114, and 120 can be located in cloud 502 (which can be public, private, or a combination where portions are public while others are private). Therefore, users 102, 302 use computing systems 502, 304 to access those systems through cloud 502.

FIG. 7 also depicts another example of a cloud architecture. FIG. 7 shows that it is also contemplated that some elements of computing system architectures 100, 300 can be disposed in cloud 502 while others are not. By way of example, data stores 110, 114, 120 can be disposed outside of cloud 502, and accessed through cloud 502. In another example, evaluation clients 104, LLMs 118 (or other items) can be outside of cloud 502. Regardless of where the items are located, the items can be accessed directly by device 504, through a network (either a wide area network or a local area network), the items can be hosted at a remote site by a service, or the items can be provided as a service through a cloud or accessed by a connection service that resides in the cloud. All of these architectures are contemplated herein.

It will also be noted that architectures 100, 300, or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

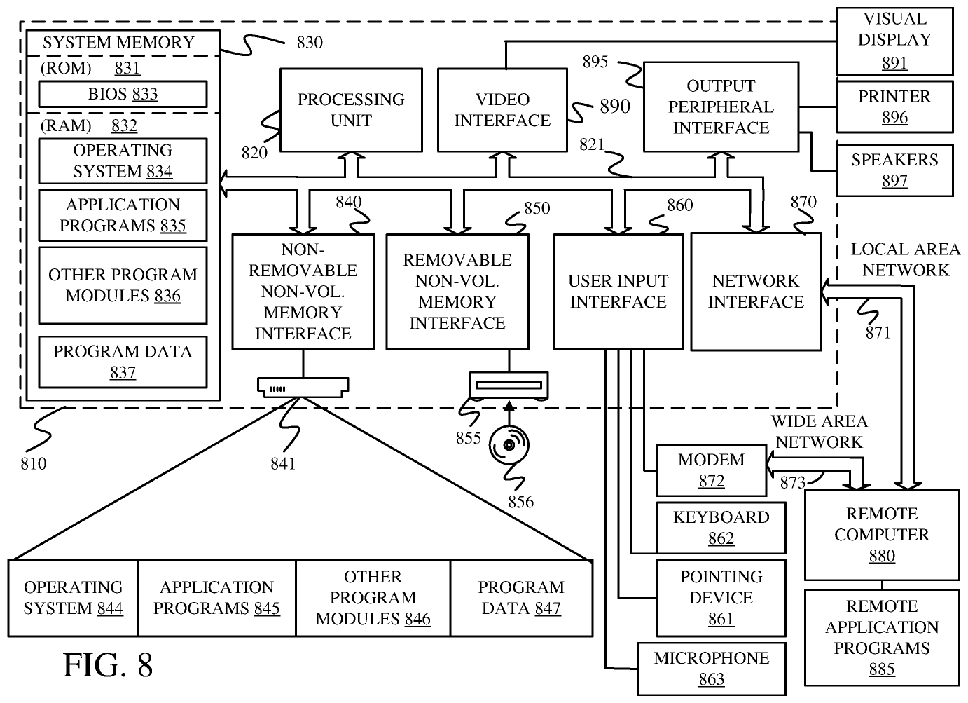

FIG. 8 is one example of a computing environment in which architectures 100, 300, or parts of them, (for example) can be deployed. With reference to FIG. 8, an example system for implementing some embodiments includes a computing device in the form of a computer 810 programmed to operate as described above. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIGS. 1 and 3 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computer implemented method, comprising:
receiving an evaluation request, from an evaluation client, requesting evaluation of a generative artificial intelligence (AI) system;
parsing the evaluation request to identify evaluation parameters;
selecting an evaluation template, of a plurality of evaluation templates, based on the evaluation parameters, each of the plurality of evaluation templates corresponding to a different evaluation pipeline; and
triggering the selected evaluation template to evaluate the generative AI system.

Example 2 is the computer implemented method of any or all previous examples and further comprising:
running an evaluation pipeline corresponding to the triggered evaluation template to obtain evaluation results; and
outputting the evaluation results for access by the evaluation client.

Example 3 is the computer implemented method of any or all previous examples and further comprising:
exposing a user interface (UI) with the evaluation client, the UI having user actuatable parameter selection mechanisms for interaction by a user; and
detecting user interaction with the user actuatable parameter selection mechanisms to identify the evaluation parameters.

Example 4 is the computer implemented method of any or all previous examples and further comprising:
generating the evaluation request at the evaluation client based on the identified evaluation parameters.

Example 5 is the computer implemented method of any or all previous examples wherein selecting an evaluation template comprises:
prompting an AI classifier with the evaluation parameters; and
selecting the evaluation template with the AI classifier.

Example 6 is the computer implemented method of any or all previous examples wherein selecting an evaluation template comprises:
running a set of heuristics based on the evaluation parameters; and
selecting the evaluation template with the set of heuristics.

Example 7 is the computer implemented method of any or all previous examples and further comprising:
detecting a modified pipeline definition generated at an evaluation engineer computing system, the modified pipeline definition being different from pipeline definitions corresponding to the plurality of evaluation templates; and
storing the modified pipeline definition, as one of the plurality of pipeline templates, in a pipeline repository.

Example 8 is the computer implemented method of any or all previous examples and further comprising:
detecting that the additional pipeline definition has been stored in the pipeline repository; and
generating an endpoint in the evaluation client to the pipeline template corresponding to the pipeline definition.

Example 9 is the computer implemented method of any or all previous examples and further comprising:
monitoring the pipeline repository to detect addition of further pipeline definitions; and
for each further pipeline definition added to the pipeline repository, generating an endpoint in the evaluation client to a pipeline template corresponding to the further pipeline definition.

Example 10 is the computer implemented method of any or all previous examples wherein triggering the selected evaluation template comprises:
scheduling triggering of the evaluation template on a trigger schedule based on trigger criteria; and
triggering the evaluation template based on the trigger schedule.

Example 11 is a computer system, comprising:
a pipeline selection system configured to receive an evaluation request requesting evaluation of a generative artificial intelligence (AI) system;
an evaluation request parsing system configured to identify evaluation parameters based on the evaluation request;
a pipeline repository storing a plurality of evaluation pipelines;
a pipeline selection processor configured to select an evaluation pipeline, of the plurality of evaluation pipelines, based on the evaluation parameters; and
a pipeline triggering system configured to trigger the selected evaluation pipeline to evaluate the generative AI system.

Example 12 is the computer system of any or all previous examples and further comprising:
an evaluation client configured to generate a user interface (UI) having user actuatable parameter selection mechanisms for interaction by a user and to detect user interaction with the user actuatable parameter selection mechanisms to identify the evaluation parameters.

Example 13 is the computer system of any or all previous examples wherein the evaluation client is configured to generate the evaluation request at the evaluation client based on the identified evaluation parameters.

Example 14 is the computer system of any or all previous examples and further comprising:
an evaluation result data store configured to store evaluation results generated by the selected evaluation pipeline.

Example 15 is the computer system of any or all previous examples wherein the selected evaluation pipeline further comprises:
a pipeline processor configured to run the triggered evaluation pipeline to obtain evaluation results; and
a data output system configured to output the evaluation results to the evaluation result data store for access by the evaluation client.

Example 16 is the computer system of any or all previous examples and further comprising:
an evaluation engineer computing system configured to generate a modified evaluation pipeline, that is different from the plurality of evaluation pipelines, and store the modified evaluation pipeline in the pipeline repository;
a repository monitoring system configured to detect the modified evaluation pipeline; and
a workspace propagation system configured to generate an endpoint in the evaluation client corresponding to the modified evaluation pipeline.

Example 17 is the computer system of any or all previous examples wherein the pipeline selection processor comprises:
an AI classifier configured to be prompted with the evaluation parameters and generate a selection output indicative of the selected evaluation pipeline.

Example 18 The computer system of claim 11 wherein the evaluation request is generated according to a predefined schema and wherein the evaluation request parsing system parses the evaluation request to identify the evaluation parameters in the predefined schema.

Example 19 is a computer system, comprising:
a processor;
an evaluation template selector configured to receive a set of user-selected parameters and identify an evaluation template to run; and
a template running system configured to run the selected evaluation template to evaluate a generative artificial intelligence (AI) system.

Example 20 is the computer system of any or all previous examples and further comprising:
a client computing system configured to generate a user interface with selection actuators and detect actuation of the selection actuators to identify the user-selected parameters and to generate a results user interface to display evaluation results generated by the selected evaluation template.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method, comprising:
receiving an evaluation request, from an evaluation client, requesting evaluation of a generative artificial intelligence (AI) system;
parsing the evaluation request to identify evaluation parameters;
selecting an evaluation template, of a plurality of evaluation templates, based on the evaluation parameters, each of the plurality of evaluation templates corresponding to a different evaluation pipeline; and
triggering the selected evaluation template to evaluate the generative AI system.

2. The computer implemented method of claim 1 and further comprising:
running an evaluation pipeline corresponding to the triggered evaluation template to obtain evaluation results; and
outputting the evaluation results for access by the evaluation client.

3. The computer implemented method of claim 1 and further comprising:
exposing a user interface (UI) with the evaluation client, the UI having user actuatable parameter selection mechanisms for interaction by a user; and
detecting user interaction with the user actuatable parameter selection mechanisms to identify the evaluation parameters.

4. The computer implemented method of claim 3 and further comprising:
generating the evaluation request at the evaluation client based on the identified evaluation parameters.

5. The computer implemented method of claim 1 wherein selecting an evaluation template comprises:
prompting an AI classifier with the evaluation parameters; and
selecting the evaluation template with the AI classifier.

6. The computer implemented method of claim 1 wherein selecting an evaluation template comprises:
running a set of heuristics based on the evaluation parameters; and
selecting the evaluation template with the set of heuristics.

7. The computer implemented method of claim 1 and further comprising:
detecting a modified pipeline definition generated at an evaluation engineer computing system, the modified pipeline definition being different from pipeline definitions corresponding to the plurality of evaluation templates; and
storing the modified pipeline definition, as one of the plurality of pipeline templates, in a pipeline repository.

8. The computer implemented method of claim 7 and further comprising:
detecting that the additional pipeline definition has been stored in the pipeline repository; and
generating an endpoint in the evaluation client to the pipeline template corresponding to the pipeline definition.

9. The computer implemented method of claim 7 and further comprising:
monitoring the pipeline repository to detect addition of further pipeline definitions; and
for each further pipeline definition added to the pipeline repository, generating an endpoint in the evaluation client to a pipeline template corresponding to the further pipeline definition.

10. The computer implemented method of claim 1 wherein triggering the selected evaluation template comprises:
scheduling triggering of the evaluation template on a trigger schedule based on trigger criteria; and
triggering the evaluation template based on the trigger schedule.

11. A computer system, comprising:
a pipeline selection system configured to receive an evaluation request requesting evaluation of a generative artificial intelligence (AI) system;
an evaluation request parsing system configured to identify evaluation parameters based on the evaluation request;
a pipeline repository storing a plurality of evaluation pipelines;
a pipeline selection processor configured to select an evaluation pipeline, of the plurality of evaluation pipelines, based on the evaluation parameters; and
a pipeline triggering system configured to trigger the selected evaluation pipeline to evaluate the generative AI system.

12. The computer system of claim 11 and further comprising:
an evaluation client configured to generate a user interface (UI) having user actuatable parameter selection mechanisms for interaction by a user and to detect user interaction with the user actuatable parameter selection mechanisms to identify the evaluation parameters.

13. The computer system of claim 12 wherein the evaluation client is configured to generate the evaluation request at the evaluation client based on the identified evaluation parameters.

14. The computer system of claim 12 and further comprising:
an evaluation result data store configured to store evaluation results generated by the selected evaluation pipeline.

15. The computer system of claim 14 wherein the selected evaluation pipeline further comprises:
a pipeline processor configured to run the triggered evaluation pipeline to obtain evaluation results; and
a data output system configured to output the evaluation results to the evaluation result data store for access by the evaluation client.

16. The computer system of claim 11 and further comprising:
an evaluation engineer computing system configured to generate a modified evaluation pipeline, that is different from the plurality of evaluation pipelines, and store the modified evaluation pipeline in the pipeline repository;
a repository monitoring system configured to detect the modified evaluation pipeline; and
a workspace propagation system configured to generate an endpoint in the evaluation client corresponding to the modified evaluation pipeline.

17. The computer system of claim 11 wherein the pipeline selection processor comprises:
an AI classifier configured to be prompted with the evaluation parameters and generate a selection output indicative of the selected evaluation pipeline.

18. The computer system of claim 11 wherein the evaluation request is generated according to a predefined schema and wherein the evaluation request parsing system parses the evaluation request to identify the evaluation parameters in the predefined schema.

19. A computer system, comprising:
a processor;
an evaluation template selector configured to receive a set of user-selected parameters and identify an evaluation template to run; and
a template running system configured to run the selected evaluation template to evaluate a generative artificial intelligence (AI) system.

20. The computer system of claim 19 and further comprising:
a client computing system configured to generate a user interface with selection actuators and detect actuation of the selection actuators to identify the user-selected parameters and to generate a results user interface to display evaluation results generated by the selected evaluation template.
